(19) United States
(12) Patent Application Publication
(10) Pub. No.: US 2011/0314904 A1
(43) Pub. Date: Dec. 29, 2011

(54) FUEL AMOUNT MEASURING DEVICE FOR VEHICLE

(75) Inventors: KyungHwan KIM, Yeongi-gun (KR); Jeongsik Kim, Daejeon (KR)

(73) Assignee: COAVIS, Yeongi-gun (KR)

(21) Appl. No.: 13/166,300

(22) Filed: Jun. 22, 2011

(30) Foreign Application Priority Data
Jun. 23, 2010 (KR) 10-2010-0059496

(51) Int. Cl. G01M 15/00

(52) U.S. Cl. 73/114.54

(57) ABSTRACT

Provided is a fuel amount measuring device for a vehicle positioned in a fuel tank of the vehicle to thereby measure an amount of remaining fuel. The fuel amount measuring device is implemented as a mechanical fuel amount measuring device including a base body, a resistive substrate, a retainer, and a contactor contacting the resistive substrate, wherein the resistive substrate and the contactor include a conductive film positioned therebetween and coated with a conductive material, such that the contactor and the resistive substrate are connected to each other by the conductive film. With the fuel amount measuring device, abrasion of the resistive substrate is prevented, thereby making it possible to improve durability of the fuel amount measuring device. In addition, the base body and the conductive film are closely adhered to each other, having the resistive substrate therebetween, such that the resistive substrate does not contact fuel, thereby making it possible to prevent corrosion of the resistive substrate. As a result, it is possible to comparatively accurately measure an amount of remaining fuel

### CROSS-REFERENCE TO RELATED APPLICATIONS

This application claims priority under 35 U.S.C. §119 to Korean Patent Application No. 10-2010-0059496, filed on 23 Jun. 2010, in the Korean Intellectual Property Office, the disclosure of which is incorporated herein by reference in its entirety.

### TECHNICAL FIELD

The following disclosure relates to a fuel amount measuring device for a vehicle positioned in a fuel tank of the vehicle to thereby measure an amount of remaining fuel.

### BACKGROUND

It is very important to accurately measure an amount of remaining fuel in a vehicle in order to efficiently drive the vehicle and secure security.

A fuel amount measuring device for measuring an amount of remaining fuel stored in a fuel tank is used in the vehicle.

The fuel amount measuring device according to the related art is divided into a mechanical fuel amount measuring device and an electronic fuel amount measuring device.

The mechanical fuel amount measuring device is configured to include a base body 1, a resistive substrate 2, a retainer 3, and a contactor 4 (also referred to as a ‘wiper’), and measures a fuel amount by measuring a resistance value because a height of a floater changes according to a change in fuel amount.

The electronic fuel amount measuring device measures a fuel amount using a sensor.

The mechanical fuel amount measuring device has been mainly used, as compared to the electronic fuel amount measuring device.

However, in the case of the mechanical fuel amount measuring device according to the related art, since the contactor and the resistive substrate are in direct contact with each other and are constantly in contact with each other, they become rapidly worn out. In addition, the resistive substrate is rapidly corroded due to reasons such as contact between the resistive substrate and fuel, or the like.

Since these problems cause deterioration in durability of the fuel amount measuring device and cause inaccurate measurement of the amount of remaining fuel, reliability of fuel amount measurement deteriorates in a fuel amount measuring device used for a long time.

### SUMMARY

An embodiment of the present invention is directed to providing a fuel amount measuring device for a vehicle that not only has excellent durability but does not also cause corrosion due to the fuel, or the like, in spite of being implemented as a mechanical fuel amount measuring device.

In one general aspect, a conductive film coated with a conductive material is positioned between a resistive substrate and a contactor, such that the contactor and the resistive substrate are connected to each other by the conductive film, thereby making it possible to prevent abrasion of the resistive substrate and improve durability of a fuel amount measuring device.

In addition, a base body and the conductive film are closely adhered to each other, having the resistive substrate therebetween, such that the resistive substrate does not contact fuel, thereby making it possible to prevent corrosion of the resistive substrate.

The fuel amount measuring device according to the present invention is implemented as a mechanical fuel amount measuring device including a base body, a resistive substrate, a retainer, and a contactor contacting the resistive substrate and includes a conductive film positioned between the resistive substrate and the contactor and coated with a conductive material, such that the contactor and the resistive substrate are connected to each other by the conductive film.

Other features and aspects will be apparent from the following detailed description, the drawings, and the claims.

### BRIEF DESCRIPTION OF THE DRAWINGS

FIG. 1 is a schematic view showing an assembly state of a fuel amount measuring device for a vehicle implemented as a mechanical fuel amount measuring device according to the related art;

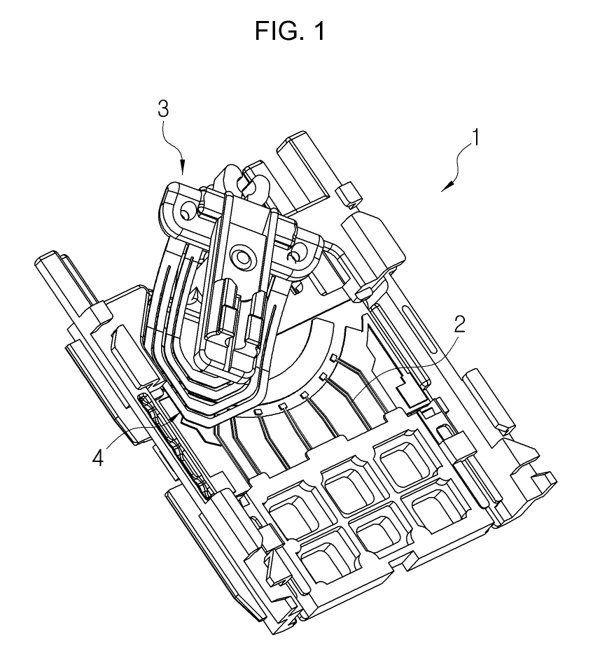

FIG. 2 is an exploded perspective view of the fuel amount measuring device for a vehicle shown in FIG. 1;

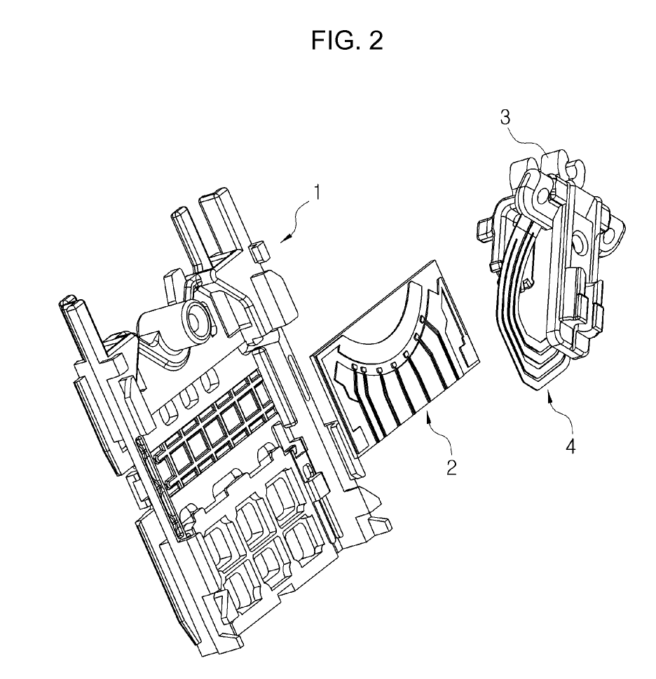

FIG. 3 is a schematic cross-sectional view of a fuel amount measuring device for a vehicle according to the present invention;

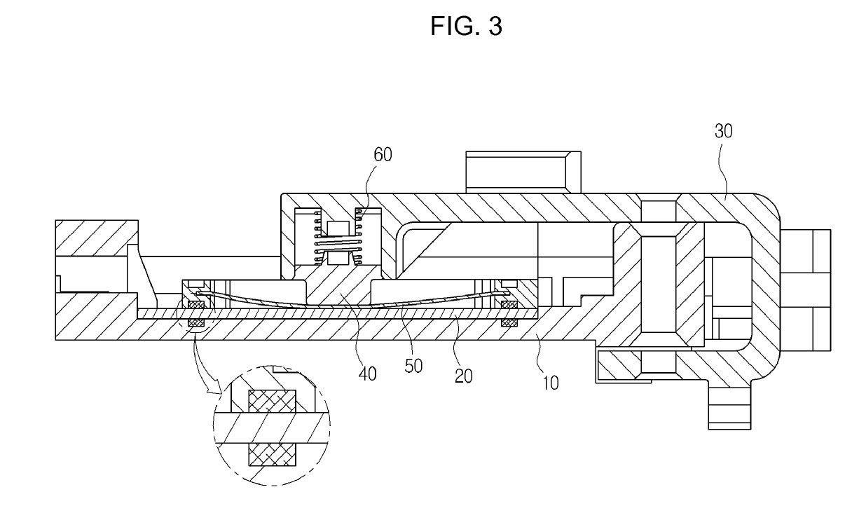

FIG. 4 is an exploded perspective view of a fuel amount measuring device for a vehicle according to the present invention; and

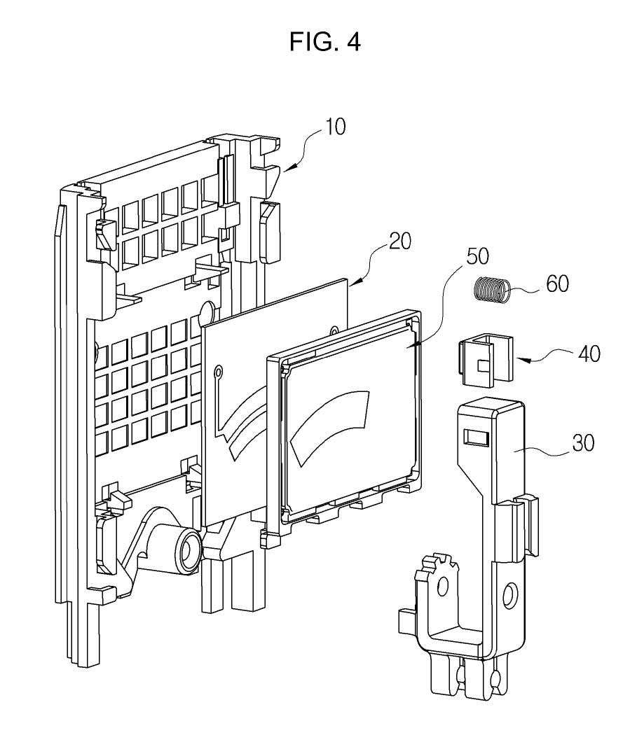

FIG. 5 is a plan view showing an assembly state of a fuel amount measuring device for a vehicle according to the present invention.

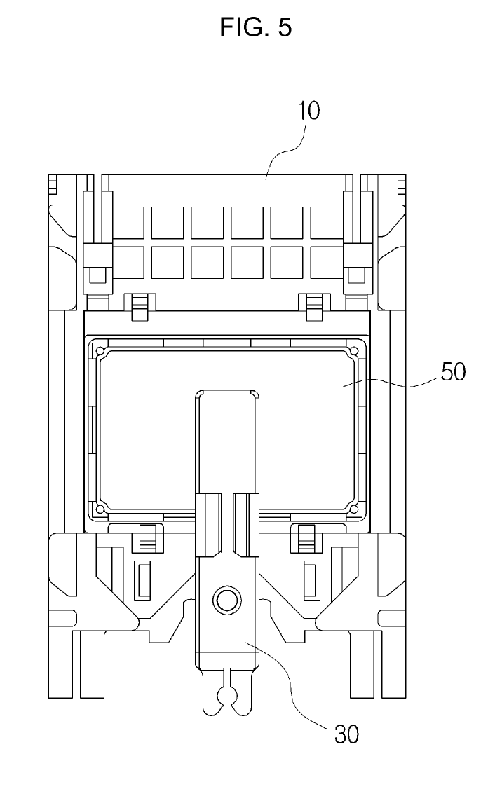

[Detailed Description of Main Elements]

| | |
|---|---|
| 1: BASE BODY | 2: RESISTIVE SUBSTRATE |
| 3: RETAINER | 4: CONTACTOR |
| 10: BASE BODY | 20: RESISTIVE SUBSTRATE |
| 30: RETAINER | 40: CONTACTOR |
| 50: CONDUCTIVE FILM | 60: ELASTIC BODY |

### DETAILED DESCRIPTION OF EMBODIMENTS

Hereinafter, a technical idea of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

The present invention relates to a fuel amount measuring device for a vehicle, and more particularly, to a mechanical fuel amount measuring device for a vehicle.

Therefore, the fuel amount measuring device according to the present invention includes a base body 10, a resistive substrate 20, a retainer 30, and a contactor 40 contacting the resistive substrate 20.

The base body 10, the resistive substrate 20, the retainer 30, the contactor 40, and the like, as described above have already been well known in the related art and may be modified into various forms. Therefore, a detailed description thereof will be omitted.

An object to the present invention is to provide a fuel amount measuring device for a vehicle that not only has excellent durability but does not also cause corrosion due to fuel, or the like, in spite of being implemented as a mechanical fuel amount measuring device.

The inventor of the present application has proposed a structure in which the resistive substrate 20 and the contactor 40 include a conductive film 50 positioned therebetween and coated with a conductive material having excellent electric conductivity, such that they are electrically connected to each other through the conductive film 50, in order to accomplish the above-mentioned object.

This structure prevents abrasion of the resistive substrate 20, such that the durability of the fuel amount measuring device is significantly improved.

In the above description, as the conductive material, silver (Ag), copper (Cu), palladium (Pd), and the like, are used. Preferably, silver (Ag) or palladium (Pd) having excellent electric conductivity is used.

According to the present invention, the base body 10 and the conductive film 50 are closely adhered to each other, having the resistive substrate 20 therebetween, such that the resistive substrate 20 does not contact the fuel.

That is, the fuel may not be introduced between the base body 10 and the conductive film 50, such that the resistive substrate 20 between the base body 10 and the conductive film 50 does not contact the fuel.

With the above-mentioned configuration, corrosion of the resistive substrate 20 due to the fuel, or the like, may be prevented, such that even though the fuel amount measuring device according to the present invention is used for a long time, it may comparatively accurately measure an amount of remaining fuel.

According to the present invention, the fuel amount measuring device may further include an elastic body 60 pushing the contactor 40 toward the conductive film 50 to thereby allow the contactor 40 to be closely adhered to the conductive film 50.

The above-mentioned elastic body 60 needs to push the contactor 40 so that the contactor may rotate horizontally while maintaining a state in which it contacts the conductive film 50.

That is, the contactor 40 needs to be closely adhered to the conductive film 50 by the elastic body 60 at a pressure within a set range.

In the above description, the pressure within the set range indicates a pressure at which the contactor 4 and the resistive substrate 2 according to the related art are in contact with each other. An appropriate range of the pressure at which the contactor 4 and the resistive substrate 2 are in contact with each other has already been well known in the related art. Therefore, a detailed description thereof will be omitted.

According to the present invention, the conductive film 50 and the resistive substrate 20 are positioned, having an interval therebetween, and the conductive film 50 is bent toward the resistive substrate 20 when being pressed by the contactor 40 to thereby contact the resistive substrate 20, such that the conductive film 50 may be connected to the resistive substrate 20 and the contactor 40.

With this configuration, it is possible to more accurately measure the amount of remaining fuel.

The fuel amount measuring device according to the present invention is implemented as a mechanical fuel amount measuring device including a base body, a resistive substrate, a retainer, and a contactor contacting the resistive substrate, wherein the resistive substrate and the contactor include a conductive film positioned therebetween and coated with a conductive material, such that the contactor and the resistive substrate are connected to each other by the conductive film. As a result, it is possible to prevent abrasion of the resistive substrate and improve durability of the fuel amount measuring device.

In addition, the base body and the conductive film are closely adhered to each other, having the resistive substrate therebetween, such that the resistive substrate does not contact fuel, thereby making it possible to prevent corrosion of the resistive substrate. As a result, it is possible to comparatively accurately measure an amount of remaining fuel.

What is claimed is:

1. A fuel amount measuring device for a vehicle, which is a mechanical type:
a base body;
a resistive substrate;
a retainer; and
a contactor contacting the resistive substrate,
wherein the resistive substrate and the contactor include a conductive film positioned therebetween and coated with a conductive material, such that they are connected to each other by the conductive film.

2. The fuel amount measuring device for a vehicle of claim 1, wherein the base body and the conductive film are closely adhered to each other, having the resistive substrate therebetween, such that the resistive substrate does not contact fuel.

3. The fuel amount measuring device for a vehicle of claim 1, wherein the conductive material coated on the conductive film includes silver (Ag) or palladium (Pd).

4. The fuel amount measuring device for a vehicle of claim 2, wherein the conductive material coated on the conductive film includes silver (Ag) or palladium (Pd).

5. The fuel amount measuring device for a vehicle of claim 2, further comprising an elastic body pushing the contactor toward the conductive film to thereby allow the contactor to be closely adhered to the conductive film.

6. The fuel amount measuring device for a vehicle of claim 5, wherein the conductive film and the resistive substrate are positioned, having an interval therebetween, and the conductive film is bent toward the resistive substrate when being pressed by the contactor to thereby contact the resistive substrate, such that the conductive film is connected to the resistive substrate and the contactor.
